(19) United States
(12) Patent Application Publication
(10) Pub. No.: US 2015/0137038 A1
(43) Pub. Date: May 21, 2015

(54) ZINC ALUMINATE MATERIAL AND METHOD FOR PREPARING SAME

(71) Applicants: Mingjie Zhou, Shenzhen (CN); Rong Wang, Shenzhen (CN); Guitang Chen, Shenzhen (CN)

(72) Inventors: Mingjie Zhou, Shenzhen (CN); Rong Wang, Shenzhen (CN); Guitang Chen, Shenzhen (CN)

(21) Appl. No.: 14/398,995

(22) PCT Filed: Jul. 31, 2012
(86) PCT No.: PCT/CN2012/079462

§ 371 Date: Nov. 5, 2014

(51) Int. Cl. C09K 11/87; C09K 11/58

(52) U.S. Cl. CPC C09K 11/87; C09K 11/58
USPC 252/301.6 R

(57) ABSTRACT

A zinc aluminate fluorescent material is provided having a formula: Zn₁₋ₓAl₂O₄:Mnₓ@Al₂O₃@M_{y}; wherein M is at least one metal nanoparticles selected from the group consisting of Ag, Au, Pt, Pd, and Cu; 0<x≦0.1; y is a mole ratio of M to Al, and 0<y≦1×10⁻²; @ represents coating, in the zinc aluminate fluorescent material, M serves as a core, Al₂O₃ serves as an intermediate layer shell, and Zn₁₋ₓAl₂O₄:Mnₓ serves as an outer layer shell. In the zinc aluminate fluorescent material, a core-shell structure is formed by coating at least one metal nanoparticles selected from the group consisting of Ag, Au, Pt, Pd, and Cu, since metal nanoparticles can improve the internal quantum efficiency of the fluorescent material, the zinc aluminate fluorescent material exhibits a higher luminous intensity. A method of preparing the zinc aluminate fluorescent material is also provided.

### FIELD OF THE INVENTION

The present disclosure relates to luminescent materials, and more particularly relates to a zinc aluminate fluorescent material and method for preparing the same.

### BACKGROUND OF THE INVENTION

Field emission display (FED) is a flat panel display technology having a great development potential. While the operating voltage of field emission display device is lower than that of the cathode ray tube (CRT), the operating current density of FED is relatively larger, e.g., about 10 to 100 μA·cm⁻². Accordingly, the fluorescent material for the field emission display requires a higher demand, such as better chromaticity, higher luminous efficiency at low voltage, and no brightness saturation phenomena at high current densities.

Currently, the study on FED mainly focuses on two aspects: one is to use and modify the existing fluorescent material for CRT; another is to search for new fluorescent material. The commercial available fluorescent material for CRT is usually based on sulfide, however, when it is used for manufacturing FED, sulfur may reacts with trace molybdenum, silicon or germanium contained in the cathode due to the instability of sulfides, which weakens the electron emission, resulting a weak FED luminous intensity.

### SUMMARY OF THE INVENTION

Accordingly, in order to address the problem of low emission intensity of existing fluorescent material, it is necessary to provide a zinc aluminate fluorescent material having a higher emission intensity and method for preparing the same.

A zinc aluminate fluorescent material has a formula:

Zn₁₋ₓAl₂O₄:Mnₓ@Al₂O₃@M_{y};

wherein M is at least one metal nanoparticles selected from the group consisting of Ag, Au, Pt, Pd, and Cu;

0<x≦0.1;

y is a mole ratio of M to Al, and 0<y≦1×10⁻²;

@ represents coating, in the zinc aluminate fluorescent material, M serves as a core, Al₂O₃ serves as an intermediate layer shell, and Zn₁₋ₓAl₂O₄:Mnₓ serves as an outer layer shell.

In one embodiment, 0.001≦x≦0.005.

In one embodiment, 1×10⁻⁵≦y≦5×10⁻³.

A method of preparing a zinc aluminate fluorescent material includes the following steps:

preparing a sol containing M, wherein M is at least one metal nanoparticles selected from the group consisting of Ag, Au, Pt, Pd, and Cu;

surface-treating the sol containing M, adding a solution containing Al³⁺ ion, stirring and adding a precipitating agent, reacting at a temperature of 0° C. to 100° C. to produce a precipitate, filtrating the precipitate, then washing, drying and calcining the precipitate to obtain Al₂O₃@M powder which coating M;

mixing a Zn compound, an Mn compound, and the Al₂O₃@M powder according to a stoichiometric ratio of formula of Zn₁₋ₓAl₂O₄:Mnₓ@Al₂O₃@M_{y} to obtain a mixture; and

grinding the mixture, heating the mixture, reducing the mixture, cooling and further grinding the mixture to obtain the zinc aluminate fluorescent material having the formula: Zn₁₋ₓAl₂O₄:Mnₓ@Al₂O₃@M_{y};

wherein 0<x≦0.1, y is a mole ratio of M to Al, and 0<y≦1×10⁻²; @ represents coating, in the zinc aluminate fluorescent material, M serves as a core, Al₂O₃ serves as an intermediate layer shell, and Zn₁₋ₓAl₂O₄:Mnₓ serves as an outer layer shell.

In one embodiment, the step of preparing the sol containing M includes:

mixing a salt solution of at least one metal nanoparticles selected from the group consisting of Ag, Au, Pt, Pd, and Cu, with an additive and a reductant, and reacting for 10 to 45 minutes to obtain the sol containing M;

wherein the concentration of the salt solution of at least one metal selected from the group consisting of Ag, Au, Pt, Pd, and Cu ranges from 1×10⁻³ mol/L to 5×10⁻² mol/L;

the additive is at least one selected from the group consisting of polyvinylpyrrolidone, sodium citrate, cetyl trimethyl ammonium bromide, sodium lauryl sulfate, and sodium dodecyl sulfate;

the concentration of the additive in the sol containing M ranges from 1×10⁴ g/mL to 5×10⁻² g/mL;

the reductant is at least one selected from the group consisting of hydrazine hydrate, ascorbic acid, sodium citrate, and sodium borohydride;

a mole ratio between the reductant and metal ion of the salt solution of at least one metal selected from the group consisting of Ag, Au, Pt, Pd, and Cu ranges from 3.6:1 to 18:1.

In one embodiment, the step of surface-treating the sol containing M includes: adding the sol containing M into an aqueous solution of polyvinyl pyrrolidone having a concentration of 0.005 g/mL to 0.01 g/mL and stirring for 12 to 24 hours.

In one embodiment, the method further includes a step of adding a surfactant after stirring and before adding the precipitating agent.

In one embodiment, the solution containing Al³⁺ ion is selected from the group consisting of aluminum sulfate solution, aluminum nitrate solution, and aluminum chloride solution; the surfactant is selected from the group consisting of polyethylene glycol, ethylene glycol, isopropyl alcohol, and polyvinyl alcohol; the precipitating agent is selected from the group consisting of ammonium bicarbonate, ammonia, ammonium carbonate, and urea.

In one embodiment, the method further includes a step of aging the precipitate for 1 to 8 hours before filtrating the precipitate.

In one embodiment, the step of calcining the precipitate comprises: calcining the precipitate at a temperature of 500° C. to 1200° C. for 1 to 8 hours.

In one embodiment, the step of heating the mixture comprises: calcining the mixture at a temperature of 800° C. to 1400° C. for 2 to 15 hours.

In one embodiment, the step of reducing the mixture comprises: heating the mixture under a mixed reducing atmosphere of nitrogen and hydrogen, a carbon reducing atmosphere or a hydrogen reducing atmosphere at a temperature of 1000° C. to 1400° C. for 0.5 to 6 hours.

In the zinc aluminate fluorescent material, a core-shell structure is formed by coating at least one metal nanoparticles selected from the group consisting of Ag, Au, Pt, Pd, and Cu, since metal nanoparticles can improve the internal quantum efficiency of the fluorescent material, the zinc aluminate fluorescent material exhibits a higher luminous intensity.

### BRIEF DESCRIPTION OF THE DRAWINGS

FIG. 1 is a flow chart of a method of preparing a zinc aluminate fluorescent material in accordance with one embodiment;

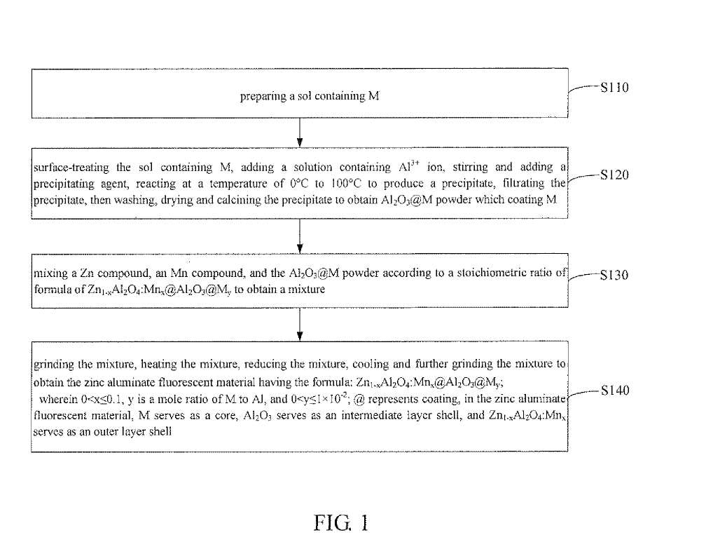

FIG. 2 is a graphical representation of cathodoluminescence spectrum under a voltage of 1.5 kV of the zinc aluminate fluorescent material of Zn_{0.992}Al₂O₄:Mn_{0.008}@Al₂O₃@Ag_{2.5×10}_{^{−}}₄ prepared in accordance with Example 3, and the luminescent material of Zn_{0.992}Al₂O₄:Mn_{0.008}@Al₂O₃ without coating metal nanoparticles.

### DETAILED DESCRIPTION OF THE EMBODIMENTS

Reference will now be made to the drawings to describe, in detail, embodiments of the present zinc aluminate fluorescent material and method for preparing the same.

A zinc aluminate fluorescent material is represented by a formula:

Zn₁₋ₓAl₂O₄:Mnₓ@Al₂O₃@M_{y};

wherein M is at least one metal nanoparticles selected from the group consisting of Ag, Au, Pt, Pd, and Cu;

0<x≦0.1; preferably 0.001≦x≦0.005.

y is a mole ratio of M to Al, and 0<y≦1×10⁻²; preferably 1×10⁻⁵≦y≦5×10⁻³;

@ represents coating, in the zinc aluminate fluorescent material, M serves as a core, Al₂O₃ serves as an intermediate layer shell, and Zn₁₋ₓAl₂O₄:Mnₓ serves as an outer layer shell.

The notation “:” in the formula Zn₁₋ₓAl₂O₄:Mnₓ represents doping, i.e., Mn is a dopant, and the divalent Mn ion is the active ion of the fluorescent material. The outer layer shell of Zn₁₋ₓAl₂O₄:Mnₓ is formed by doping manganese (Mn) into Zn₁₋ₓAl₂O₄.

Zinc aluminate (ZnAl₂O₄) is a wide bandgap semiconductor material having a cubic spinel structure. The polycrystalline powder of ZnAl₂O₄ has an optical band gap usually ranging from 318 to 319 eV, which exhibits an excellent chemical stability and thermal stability. The zinc aluminate fluorescent material employs Zinc aluminate (Zn₁₋ₓAl₂O₄) as a substrate for the outer shell layer, such that it exhibits a higher stability.

As the active ion of the zinc aluminate fluorescent material, the divalent Mn ion allows the fluorescent material to emit green fluorescence when applying the voltage.

As the core of the zinc aluminate fluorescent material, M can produce a surface plasmon resonance effect, which can improve the internal quantum efficiency of the fluorescent material.

In the zinc aluminate fluorescent material, a core-shell structure is formed by coating at least one metal nanoparticles selected from the group consisting of Ag, Au, Pt, Pd, and Cu, since metal nanoparticles can improve the internal quantum efficiency of the fluorescent material, the zinc aluminate fluorescent material exhibits a higher luminous intensity.

Accordingly, this zinc aluminate fluorescent material possesses such advantages as good stability and good luminous performance, which can be widely used in display and lighting fields.

A method of preparing a zinc aluminate fluorescent material includes the following steps:

Step S110, a sol containing M is prepared.

M is at least one metal nanoparticles selected from the group consisting of Ag, Au, Pt, Pd, and Cu.

The step of preparing the sol containing M includes: mixing a salt solution of at least one metal selected from the group consisting of Ag, Au, Pt, Pd, and Cu, with an additive and a reductant, and reacting to obtain the sol containing M. Under the premise of obtaining the sol containing M, the reacting time is preferred between 10 to 45 minutes for saving energy.

The salt solution of Ag, Au, Pt, Pd, or Cu can be chloride solution, nitrate solution and the like of Ag, Au, Pt, Pd, or Cu. The concentration of the solution of Ag, Au, Pt, Pd, or Cu can be determined as required, which preferably ranges from 1×10⁻³ mol/L to 5×10⁻² mol/L.

The additive is at least one selected from the group consisting of polyvinylpyrrolidone, sodium citrate, cetyl trimethyl ammonium bromide, sodium lauryl sulfate, and sodium dodecyl sulfate. The concentration of the additive in the sol containing M ranges from 1×10⁴ g/mL to 5×10⁻² g/mL.

The reductant is at least one selected from the group consisting of hydrazine hydrate, ascorbic acid, sodium citrate, and sodium borohydride. The reductant is first prepared into an aqueous solution having a concentration of 1×10⁻⁴ mol/L to 1 mol/L, and the aqueous solution is then mixed with the salt solution of at least one metal selected from the group consisting of Ag, Au, Pt, Pd, and Cu and the additive to perform reaction.

A mole ratio between the reductant and metal ion of the salt solution of at least one metal selected from the group consisting of Ag, Au, Pt, Pd, and Cu ranges from 3.6:1 to 18:1.

Step S120, the sol containing M is surface-treated, a solution containing Al³⁺ ion is then added. After the mixture solution is well stirred, a precipitating agent is added, the reaction is performed at a temperature of 0° C. to 100° C. to produce a precipitate. The precipitate is filtrated, then washed, dried and calcined to obtain Al₂O₃@M powder by which M is coated.

To facilitate coating, the sol containing M from step S110 is surface-treated, such that a stable Al₂O₃@M structure, in which M is coated by Al₂O₃, can be obtained.

The step of surface-treating the sol containing M includes: adding the sol containing M into an aqueous solution of polyvinyl pyrrolidone having a concentration of 0.005 g/mL to 0.01 g/mL and stirring for 12 to 24 hours.

The solution containing Al³⁺ ion is selected from the group consisting of aluminum sulfate solution (Al₂(SO₄)₃), aluminum nitrate solution (Al(NO₃)₃), and aluminum chloride solution (AlCl₃).

The precipitating agent is selected from the group consisting of ammonium bicarbonate (NH₄HCO₃), ammonia (NH₃.H₂O), ammonium carbonate ((NH₄)₂CO₃), and urea (CON₂H₄).

After the sol containing M is surface-treated, the solution containing Al³⁺ ion is then added and well stirred, the precipitating agent is slowly added with stirring, the reaction is performed in a water bath at a temperature of 0° C. to 100° C. to produce the precipitate. The reaction time is preferably from 1.5 to 5 hours to complete the formation of the precipitate.

Al³⁺ ion can react with the precipitating agent to produce Al(OH)₃, which takes a form of colloid. Since the hydroxyls of Al(OH)₃ have a high activity, the firstly generated Al(OH)₃ colloid can bind metal and coat the metal inside, next, the subsequently generated Al(OH)₃ will be deposited on the surface of the colloid particles. The hydroxyl bound to the surface of the colloid particle will be dehydrated and form an Al—O—Al band and binding points. Along with the hydrolysis, Al(OH)₃ will continuously bind to the binding points, and an Al₂O₃ coating layer is formed by dehydration and condensation, such that Al₂O₃@M is obtained.

Preferably, before adding the precipitating agent, a surfactant is added.

Before adding the surfactant, the sol containing M maintains stable mainly by electrostatic repulsion between particles. The added surfactant can be used to prevent agglomeration of the particles, thus further improving the stability of the particles.

The surfactant can form a molecular film on the surface of the colloid particles to prevent contacting between the particles, and the molecular film can reduce the surface tension and the capillary adsorption, and reduce the steric effect, such that the purpose of preventing agglomeration can be achieved. After the particle is bound with the surfactant, the bonding effect of —OH of the surface of the colloid particles can be reduced, thus further improving the dispersion of the colloid, and reducing the agglomeration of particles. The surfactant is selected from the group consisting of polyethylene glycol (PEG), ethylene glycol (EG), isopropyl alcohol (IPA), and polyvinyl alcohol ([C₂H₄O]ₙ). Preferably, the polyethylene glycol is polyethylene glycol 100-20000 (PEG100-20000), more preferably polyethylene glycol 2000-10000 (PEG2000-10000).

The polyethylene glycol with a molecular weight of 2000 to 10000 has an appropriate viscosity, such that PEG2000-10000 can easily form a strong hydrogen bond with the surface of the particles, and a macromolecular hydrophilic film is formed on the surface of the particles, so that the dispersion particles is improved, and the aggregation of particles is reduced.

Preferably, after the reaction is ended, the precipitate is aged for 1 to 8 hours, such that the generated precipitated crystal particles can grow up, and the precipitate becomes more pure and is easy for separation.

After aging, the precipitate is obtained by filtering. The precipitate is then washed, dried, and calcined at a temperature of 500 to 1200° C. for 1 to 8 hours to obtain Al₂O₃@M powder, which coats M.

Step S130, a Zn compound, an Mn compound, and the Al₂O₃@M powder are mixed according to a stoichiometric ratio of formula of Zn₁₋ₓAl₂O₄:Mnₓ@Al₂O₃@M_{y} to obtain a mixture.

The Zn compound and Mn compound are oxides, carbonates, acetates or oxalates corresponding to Zn and Mn. For example, the Zn compound can be zinc oxide (ZnO), zinc oxalate (ZnC₂O₄.2H₂O), etc.; the Mn compound can be manganese dioxide (MnO₂), manganese oxalate (MnC₂O₄.2H₂O), and the like.

The Zn compound, the Mn compound, and the Al₂O₃@M powder are mixed according to a stoichiometric ratio of formula of Zn₁₋ₓAl₂O₄:Mnₓ@Al₂O₃@M_{y} to obtain a mixture, which will be used for subsequent reaction.

Step S140, the mixture is ground, heated, reduced, cooled and further ground to obtain the zinc aluminate fluorescent material having the formula: Zn₁₋ₓAl₂O₄:Mnₓ@Al₂O₃@M_{y}, where 0<x≦0.1, y is a mole ratio of M to Al, and 0<y≦1×10⁻²; @ represents coating, in the zinc aluminate fluorescent material, M serves as a core, Al₂O₃ serves as an intermediate layer shell, and Zn₁₋ₓAl₂O₄:Mnₓ serves as an outer layer shell.

The mixture obtained in step S130 is well ground, then is calcined at a temperature of 800° C. to 1400° C. for 2 to 15 hours. Next, the mixture is reduced under a mixed reducing atmosphere of nitrogen and hydrogen, a carbon reducing atmosphere or a hydrogen reducing atmosphere at a temperature of 1000° C. to 1400° C. for 0.5 to 6 hours.

After reducing, the mixture is cooled, ground to obtain the zinc aluminate fluorescent material having the formula: Zn₁₋ₓAl₂O₄:Mnₓ@Al₂O₃@M_{y}.

In the formula, 0<x≦0.1, y is a mole ratio of M to Al, and 0<y≦1×10⁻²; @ represents coating, in the zinc aluminate fluorescent material, M serves as a core, Al₂O₃ serves as an intermediate layer shell, and Zn₁₋ₓAl₂O₄:Mnₓ serves as an outer layer shell.

The notation “:” in the formula Zn₁₋ₓAl₂O₄:Mnₓ represents doping, i.e., Mn is a dopant, and the divalent Mn ion is the active ion of the fluorescent material. The outer layer shell of Zn₁₋ₓAl₂O₄:Mnₓ is formed by doping manganese (Mn) into Zn₁₋ₓAl₂O₄:Mnₓ.

The forgoing preparing method of the zinc aluminate fluorescent material is simple, low equipment requirement, no pollution, easy to control, and suitable for industrial production.

Detailed examples are described below.

### Example 1

This example describes a process of preparation of Zn_{0.99}Al₂O₄:Mn_{0.01}@Al₂O₃@Pd_{1×10}_{^{−}}₅ by using high-temperature solid-phase method.

Preparation of sol containing Pd nanoparticles was described below. 0.22 mg of palladium chloride (PdCl₂.2H₂O) was dissolved in 19 mL of deionized water. After the palladium chloride was fully dissolved, 11.0 mg of sodium citrate and 4.0 mg of sodium lauryl sulfate were weighed and dissolved into the palladium chloride aqueous solution under magnetic stirring. 3.8 mg of sodium borohydride was weighed and dissolved into 10 mL of deionized water to obtain a sodium borohydride reducing solution with a concentration of 1×10⁻² mol/L. Under magnetic stirring, 1 mL of sodium borohydride solution with a concentration of 1×10⁻² mol/L was fast added to the palladium chloride aqueous solution. After reaction for 20 minutes, 20 mL of sol containing Pd nanoparticles was obtained with a Pd content of 5×10⁻⁵ mol/L.

Preparation of Al₂O₃@Pd was described below. 0.20 g of polyvinylpyrrolidone was dissolved in 4 mL of deionized water under a room temperature, 1.2 mL of 5×10⁻⁵ mol/L of sol containing Pd nanoparticles was added and stirred for 12 hours, 6 mL of 0.5 mol/L of Al₂(SO₄)₃ solution and 10 mL of 10% (V/V) of PEG100 aqueous solution were added with stirring, 20 mL of 2 mol/L of urea was then slowly added dropwise. The mixed solution was stirred and reacted in a water bath at 100° C. for 2.5 hours, aged for 1 hour, filtered, washed, dried, and heat-treated at 1200° C. for 1 hour to obtain Al₂O₃@Pd powder.

Preparation of Zn_{0.99}Al₂O₄:Mn_{0.01}@Al₂O₃@Pd_{1×10}_{^{−}}₅ was described below. 0.3750 g of ZnC₂O₄.2H₂O, 0.2039 g of Al₂O₃@Pd, 0.0036 g of MnC₂O₄.2H₂O were weighed and placed in an agate mortar, sufficient ground to form well mixed powder. The powder was transferred to a corundum crucible, heated at 1400° C. for 2 hours in a muffle furnace. Next, the powder was sintered and reduced at 1400° C. in a tube furnace under a weak reducing atmosphere of carbon for 0.5 hr, then cooled to room temperature and ground to obtain zinc aluminate fluorescent material of Zn_{0.99}Al₂O₄:Mn_{0.01}@Al₂O₃@Pd_{1×10}_{^{−}}₅ coating Pd nanoparticles.

### Example 2

This example describes a process of preparation of Zn_{0.98}Al₂O₄:Mn_{0.02}@Al₂O₃@AU_{1.5×10}_{^{−}}₄ by using high-temperature solid-phase method.

Preparation of sol containing Au nanoparticles was described below. 2.1 mg of chloroauric acid (AuCl₃.HCl.4H₂O) was dissolved in 16.8 mL of deionized water. After the chloroauric acid was fully dissolved, 14 mg of sodium citrate and 6 mg of cetyl trimethyl ammonium bromide were weighed and dissolved into the chloroauric acid aqueous solution under magnetic stirring. 1.9 mg of sodium borohydride and 17.6 mg of ascorbic acid were weighed and dissolved into 10 mL of deionized water, respectively, to obtain a 10 mL of sodium borohydride solution with a concentration of 1×10⁻² mol/L and a 10 mL of ascorbic acid solution with a concentration of 1×10⁻² mol/L. Under magnetic stirring, 0.08 mL of sodium borohydride solution was firstly added to the chloroauric acid aqueous solution, after stirring for 5 minutes, 3.12 mL of ascorbic acid solution with a concentration of 1×10⁻² mol/L was then added to the chloroauric acid aqueous solution. After reaction for 30 minutes, 20 mL of sol containing Au nanoparticles was obtained with an Au content of 5×10⁻⁴ mol/L.

Preparation of Al₂O₃@Au was described below. 0.5 g of PVP was dissolved in 10 mL of deionized water under a room temperature, 10.8 mL of 5×10⁻⁴ mol/L of sol containing Au nanoparticles was added and stirred for 24 hours, 6 mL of 0.5 mol/L of Al₂(SO₄)₃ solution and 5 mL of 5% (V/V) of PEG20000 aqueous solution were added with stirring, 20 mL of 3 mol/L of urea was then slowly added dropwise. The mixed solution was stirred and reacted in a water bath at 80° C. for 1.5 hours, aged for 8 hours, filtered, washed, dried, and heat-treated at 800° C. for 2 hours to obtain Al₂O₃@Au powder.

Preparation of Zn_{0.98}Al₂O₄:Mn_{0.02}@Al₂O₃@Au_{1.5×10}_{^{−}}₄ was described below. 0.3073 g of ZnCO₃, 0.2549 g of Al₂O₃@Au, 0.0057 g of MnCO₃ were weighed and placed in an agate mortar, sufficient ground to form well mixed powder. The powder was transferred to a corundum crucible, heated at 800° C. for 15 hours in a muffle furnace. Next, the powder was sintered and reduced at 1000° C. in a tube furnace under a weak reducing atmosphere of 95% N₂+5% H₂ for 4 hours, then cooled to room temperature and ground to obtain zinc aluminate fluorescent material of Zn_{0.98}Al₂O₄:Mn_{0.02}@Al₂O₃@Au_{1.5×10}_{^{−}}₄ coating Au nanoparticles.

### Example 3

This example describes a process of preparation of Zn_{0.992}Al₂O₄:Mn_{0.008}@Al₂O₃@Ag_{2.5×10}_{^{−}}₄ by using high-temperature solid-phase method.

Preparation of sol containing Ag nanoparticles was described below. 3.4 mg of silver nitrate (AgNO₃) was dissolved in 18.4 mL of deionized water. After the silver nitrate was fully dissolved, 42 mg of sodium citrate was weighed and dissolved into the silver nitrate aqueous solution under magnetic stirring. 5.7 mg of sodium borohydride was weighed and dissolved into 10 mL of deionized water to obtain a 10 mL of sodium borohydride solution with a concentration of 1.5×10⁻² mol/L. Under magnetic stirring, 1.6 mL of sodium borohydride solution (1.5×10⁻² mol/L) was added to the silver nitrate aqueous solution. After reaction for 10 minutes, 20 mL of sol containing Ag nanoparticles was obtained with an Ag content of 1×10⁻³ mol/L.

Preparation of Al₂O₃@Ag was described below. 0.1 g of polyvinylpyrrolidone was dissolved in 4 mL of deionized water under a room temperature, 3 mL of 1×10⁻³ mol/L of sol containing Ag nanoparticles was added and stirred for 12 hours, 12 mL of 1 mol/L of Al(NO₃)₃ solution and 6 mL of 4% (V/V) of polyvinyl alcohol aqueous solution were added with stirring, NH₃.H₂O was then slowly added dropwise under vigorous stirring until pH=9. The mixed solution was stirred and reacted for 3 hours, aged for 5 hours, filtered, washed, dried, and heat-treated at 900° C. for 4 hours to obtain Al₂O₃@Ag powder.

Preparation of Zn_{0.992}Al₂O₄:Mn_{0.008}@Al₂O₃@Ag_{2.5×10}_{^{−}}₄ was described below. 0.3249 g of ZnO, 0.4078 g of Al₂O₃@Ag, 0.0078 g of Mn(CH₃COO)₂.4H₂O were weighed and placed in an agate mortar, sufficient ground to form well mixed powder. The powder was transferred to a corundum crucible, heated at 1250° C. for 4 hours in a muffle furnace. Next, the powder was sintered and reduced at 1200° C. in a tube furnace under a weak reducing atmosphere of 95% N₂+5% H₂ for 2 hours, then cooled to room temperature and ground to obtain zinc aluminate fluorescent material of Zn_{0.992}Al₂O₄:Mn_{0.008}@Al₂O₃@Ag_{2.5×10}_{^{−}}₄ coating Ag nanoparticles.

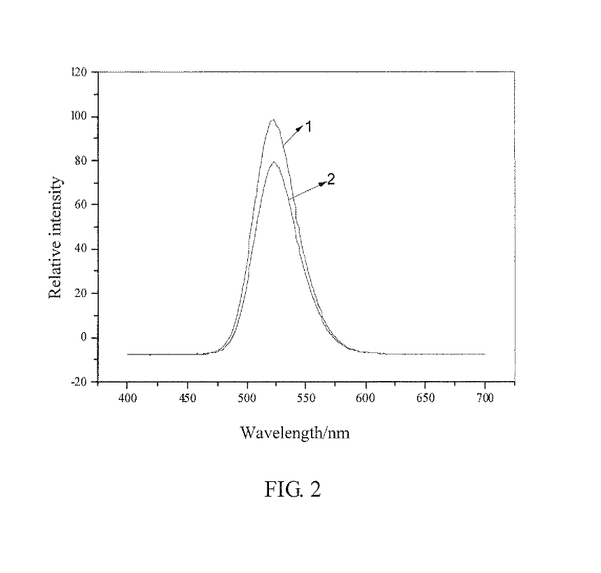

FIG. 2 is a graphical representation of cathodoluminescence spectrum under a voltage of 1.5 kV of the zinc aluminate fluorescent material of Zn_{0.992}Al₂O₄:Mn_{0.008}@Al₂O₃@Ag_{2.5×10}_{^{−}}₄ coating Ag nanoparticles prepared in accordance with Example 3, and the zinc aluminate fluorescent material of Zn_{0.992}Al₂O₄:Mn_{0.008}@Al₂O₃ without coating metal nanoparticles. It can be seen from FIG. 2 that, at an emission peak of 525 nm, the emission intensity of zinc aluminate fluorescent material of Zn_{0.992}Al₂O₄:Mn_{0.008}@Al₂O₃@Ag_{2.5×10}_{^{−}}₄ coating Ag nanoparticles is enhanced by 24% comparing to zinc aluminate fluorescent material of Zn_{0.992}Al₂O₄:Mn_{0.008}@Al₂O₃ without coating metal nanoparticles. Accordingly, the zinc aluminate fluorescent material according to Example 3 has a good stability, good color purity and high luminous efficiency.

### Example 4

This example describes a process of preparation of Zn_{0.95}Al₂O₄:Mn_{0.05}@Al₂O₃@Pt_{5×10}_{^{−}}₃ by using high-temperature solid-phase method.

Preparation of sol containing Pt nanoparticles was described below. 103.6 mg of chloroplatinic acid (H₂PtCl₆.6H₂O) was dissolved in 17 mL of deionized water. After the chloroplatinic acid was fully dissolved, 40.0 mg of sodium citrate and 60.0 mg of sodium lauryl sulfate were weighed and dissolved into the chloroplatinic acid aqueous solution under magnetic stirring. 1.9 mg of sodium borohydride was weighed and dissolved into 10 mL of deionized water to obtain 10 mL of sodium borohydride aqueous solution with a concentration of 5×10⁻³ mol/L. 10 mL of hydrazine hydrate solution (5×10⁻² mol/L) was prepared at the same time. Under magnetic stirring, 0.4 mL of sodium borohydride solution was added dropwise to the chloroplatinic acid aqueous solution and stirred for 5 minutes, then 2.6 mL of hydrazine hydrate was added dropwise to the chloroplatinic acid aqueous solution. After reaction for 40 minutes, 10 mL of sol containing Pt nanoparticles was obtained with a Pt content of 1×10⁻² mol/L.

Preparation of Al₂O₃@Pd was described below. 0.30 g of polyvinylpyrrolidone (PVP) was dissolved in 5 mL of deionized water under a room temperature, 6 mL of 1×10⁻² mol/L of sol containing Pt nanoparticles was added and stirred for 18 hours, 12 mL of 1 mol/L of AlCl₃ solution and 5 mL of isopropanol were added with stirring, 30 mL of 4 mol/L of NH₄HCO₃ was then slowly added dropwise. The mixed solution was stirred and reacted for 5 hours, aged for 4 hours, filtered, washed, dried, and heat-treated at 500° C. for 8 hour to obtain Al₂O₃@Pt powder.

Preparation of Zn_{0.95}Al₂O₄:Mn_{0.05}@Al₂O₃@Pt_{5×10}_{^{−}}₃ was described below. 0.8341 g of Zn(CH₃COO)₂.2H₂O, 0.4078 g of Al₂O₃@Pt, 0.0490 g of Mn(CH₃COO)₂.4H₂O were weighed and placed in an agate mortar, sufficient ground to form well mixed powder. The powder was transferred to a corundum crucible, heated at 1100° C. for 10 hours in a muffle furnace. Next, the powder was sintered and reduced at 1000° C. in a tube furnace under a H₂ reducing atmosphere for 6 hours, then cooled to room temperature and ground to obtain zinc aluminate fluorescent material of Zn_{0.95}Al₂O₄:Mn_{0.05}@Al₂O₃@Pt_{5×10}_{^{−}}₃ coating Pt nanoparticles.

### Example 5

This example describes a process of preparation of Zn_{0.999}Al₂O₄:Mn_{0.001}@Al₂O₃@Cu_{1×10}_{^{−}}₄ by using high-temperature solid-phase method.

Preparation of sol containing Cu nanoparticles was described below. 2.4 mg of copper nitrate was dissolved in 16 mL of ethanol. After the copper nitrate was fully dissolved, 12 mg of PVP was added with stirring. 0.4 mg of sodium borohydride was dissolved into 10 mL of ethanol to obtain a sodium borohydride alcoholic solution with a concentration of 1×10⁻³ mol/L. 4 mL of sodium borohydride alcoholic solution was added dropwise to the copper nitrate solution. After stirring and reacting for 10 minutes, 20 mL of sol containing Cu nanoparticles was obtained with a Cu content of 6×10⁻⁴ mol/L.

Preparation of Al₂O₃@Cu was described below. 0.18 g of PVP was dissolved in 8 mL of deionized water under a room temperature, 2 mL of 6×10⁻⁴ mol/L of sol containing Cu nanoparticles was added and stirred for 24 hours, 6 mL of 2 mol/L of AlCl₃ solution and 8 mL of 5% (V/V) of PEG10000 were added with stirring, 15 mL of 3 mol/L of NH₄HCO₃ was then slowly added dropwise. The mixed solution was stirred and reacted in a 60° C. water bath for 5 hours, aged for 3 hours, filtered, washed, dried, and heat-treated at 600° C. for 6 hours to obtain Al₂O₃@Cu powder.

Preparation of Zn_{0.999}Al₂O₄:Mn_{0.001}@Al₂O₃@Cu_{1×10}_{^{−}}₄ was described below. 0.3252 g of ZnO, 0.4078 g of Al₂O₃@Cu, 0.0009 g Mn(CH₃COO)₂.4H₂O were weighed and placed in an agate mortar, sufficient ground to form well mixed powder. The powder was transferred to a corundum crucible, heated at 1100° C. for 10 hours in a muffle furnace. Next, the powder was sintered and reduced at 1000° C. in a tube furnace under a 95%+5% H₂ reducing atmosphere for 6 hours, then cooled to room temperature and ground to obtain zinc aluminate fluorescent material of Zn_{0.999}Al₂O₄:Mn_{0.001}@Al₂O₃@Cu_{1×10}_{^{−}}₄ coating Cu nanoparticles.

### Example 6

This example describes a process of preparation of Zn_{0.9}Al₂O₄:Mn_{0.1}@Al₂O₃@(Ag_{0.5}/AU_{0.5})_{1.25×10}_{^{−}}₃ by using high-temperature solid-phase method.

Preparation of sol containing Ag_{0.5}/Au_{0.5} nanoparticles was described below. 6.2 mg of chloroauric acid (AuCl₃.HCl.4H₂O) and 2.5 mg of AgNO₃ were dissolved in 28 mL of deionized water. After they were fully dissolved, 22 mg of sodium citrate and 20 mg of PVP were weighed and added to the mixture solution under magnetic stirring. 5.7 mg of sodium borohydride was dissolved into 10 mL of deionized water to obtain a sodium borohydride aqueous solution with a concentration of 1.5×10⁻² mol/L. 2 mL of sodium borohydride aqueous solution (1.5×10⁻² mol/L) was added to the mixture solution. After stirring and reacting for 20 minutes, 30 mL of sol containing Ag_{0.5}/Au_{0.5} nanoparticles was obtained with a sum metal (Ag+Au) content of 1×10⁻³ mol/L.

Preparation of Al₂O₃@(Ag_{0.5}/Au_{0.5}) was described below. 0.25 g of PVP was dissolved in 6 mL of deionized water under a room temperature, 10 mL of 1×10⁻³ mol/L of sol containing Ag_{0.5}/Au_{0.5} nanoparticles was added and stirred for 24 hours, 8 mL of 1 mol/L of AlCl₃ solution and 5 mL of glycol were added with stirring, 20 mL of 5 mol/L of (NH₄)₂CO₃ was then slowly added dropwise. The mixed solution was stirred and reacted in a 70° C. water bath for 3 hours, aged for 2 hours, filtered, washed, dried, and heat-treated at 900° C. for 3 hours to obtain Al₂O₃@(Ag_{0.5}/Au_{0.5}) powder.

Preparation of Zn_{0.9}Al₂O₄:Mn_{0.1}@Al₂O₃@(Ag_{0.5}/Au_{0.5})_{1.25×10}_{^{−}}₃ was described below. 0.2930 g of ZnO, 0.4078 g of Al₂O₃@(Ag_{0.5}/Au_{0.5}), 0.0347 g of MnO₂ were weighed and placed in an agate mortar, sufficient ground to form well mixed powder. The powder was transferred to a corundum crucible, heated at 1000° C. for 15 hours in a muffle furnace. Next, the powder was sintered and reduced at 1000° C. in a tube furnace under a 95%+5% H₂ reducing atmosphere for 4 hours, then cooled to room temperature and ground to obtain zinc aluminate fluorescent material of Zn_{0.9}Al₂O₄:Mn_{0.1}@Al₂O₃@(Ag_{0.5}/Au_{0.5})_{1.25×10}_{^{−}}₃ coating Ag/Au nanoparticles.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A zinc aluminate fluorescent material, having a formula: Zn₁₋ₓAl₂O₄:Mnₓ@Al₂O₃@M_{y} wherein M is at least one metal nanoparticles selected from the group consisting of Ag, Au, Pt, Pd, and Cu;
0<x≦0.1;
y is a mole ratio of M to Al, and 0<y≦1×10⁻²;
@ represents coating, in the zinc aluminate fluorescent material, M serves as a core, Al₂O₃ serves as an intermediate layer shell, and Zn₁₋ₓAl₂O₄:Mnₓ serves as an outer layer shell.

2. The zinc aluminate fluorescent material according to claim 1, wherein 0.001≦x≦0.005.

3. The zinc aluminate fluorescent material according to claim 1, wherein 1×10⁻⁵≦y≦5×10⁻³.

4. A method of preparing a zinc aluminate fluorescent material, comprising the following steps:
preparing a sol containing M, wherein M is at least one metal nanoparticles selected from the group consisting of Ag, Au, Pt, Pd, and Cu;
surface-treating the sol containing M, adding a solution containing Al³⁺ ion, stirring and adding a precipitating agent, reacting at a temperature of 0° C. to 100° C. to produce a precipitate, filtrating the precipitate, then washing, drying and calcining the precipitate to obtain Al₂O₃@M powder which coating M;
mixing a Zn compound, an Mn compound, and the Al₂O₃@M powder according to a stoichiometric ratio of formula of Zn₁₋ₓAl₂O₄:Mnₓ@Al₂O₃@M_{y} to obtain a mixture; and grinding the mixture, heating the mixture, reducing the mixture, cooling and further grinding the mixture to obtain the zinc aluminate fluorescent material having the formula:
Zn₁₋ₓAl₂O₄:Mnₓ@Al₂O₃@M_{y};
wherein 0<x≦0.1, y is a mole ratio of M to Al, and 0<y≦1×10⁻²; @ represents coating, in the zinc aluminate fluorescent material, M serves as a core, Al₂O₃ serves as an intermediate layer shell, and Zn₁₋ₓAl₂O₄:Mnₓ serves as an outer layer shell.

5. The method according to claim 4, wherein the step of preparing the sol containing M comprises:
mixing a salt solution of at least one metal nanoparticles selected from the group consisting of Ag, Au, Pt, Pd, and Cu, with an additive and a reductant, and reacting for 10 to 45 minutes to obtain the sol containing M;
wherein the concentration of the salt solution of at least one metal selected from the group consisting of Ag, Au, Pt, Pd, and Cu ranges from 1×10⁻³ mol/L to 5×10⁻² mol/L;
the additive is at least one selected from the group consisting of polyvinylpyrrolidone, sodium citrate, cetyl trimethyl ammonium bromide, sodium lauryl sulfate, and sodium dodecyl sulfate;
the concentration of the additive in the sol containing M ranges from 1×10⁻⁴ g/mL to 5×10⁻² g/mL;
the reductant is at least one selected from the group consisting of hydrazine hydrate, ascorbic acid, sodium citrate, and sodium borohydride;
a mole ratio between the reductant and metal ion of the salt solution of at least one metal selected from the group consisting of Ag, Au, Pt, Pd, and Cu ranges from 3.6:1 to 18:1.

6. The method according to claim 4, wherein the step of surface-treating the sol containing M comprises: adding the sol containing M into an aqueous solution of polyvinyl pyrrolidone having a concentration of 0.005 g/mL to 0.01 g/mL and stirring for 12 to 24 hours.

7. The method according to claim 4, further comprising a step of adding a surfactant after stirring and before adding the precipitating agent.

8. The method according to claim 7, wherein the solution containing Al³⁺ ion is selected from the group consisting of aluminum sulfate solution, aluminum nitrate solution, and aluminum chloride solution; the surfactant is selected from the group consisting of polyethylene glycol, ethylene glycol, isopropyl alcohol, and polyvinyl alcohol; the precipitating agent is selected from the group consisting of ammonium bicarbonate, ammonia, ammonium carbonate, and urea.

9. The method according to claim 4, further comprising a step of aging the precipitate for 1 to 8 hours before filtrating the precipitate.

10. The method according to claim 4, wherein the step of calcining the precipitate comprises: calcining the precipitate at a temperature of 500° C. to 1200° C. for 1 to 8 hours.

11. The method according to claim 4, wherein the step of heating the mixture comprises: calcining the mixture at a temperature of 800° C. to 1400° C. for 2 to 15 hours.

12. The method according to claim 4, wherein the step of reducing the mixture comprises: heating the mixture under a mixed reducing atmosphere of nitrogen and hydrogen, a carbon reducing atmosphere or a hydrogen reducing atmosphere at a temperature of 1000° C. to 1400° C. for 0.5 to 6 hours.
